(19) United States
(12) Patent Application Publication
(10) Pub. No.: US 2024/0023584 A1
(43) Pub. Date: Jan. 25, 2024

(54) PRODUCTION OF PROTEIN-CARBOHYDRATE CONJUGATES AS EMULSIFIERS

(71) Applicant: SYMRISE AG, Holzminden (DE)

(72) Inventors: Marina EICHHORN, Berlin (DE); Stephan DRUSCH, Berlin (DE); Jenny WEISSBRODT, Holzminden (DE)

(21) Appl. No.: 18/256,458

(22) PCT Filed: Dec. 10, 2020
(86) PCT No.: PCT/EP2020/085426

§ 371 Date: Jun. 8, 2023

(51) Int. Cl. A23L 29/10; A23D 7/005

(52) U.S. Cl. CPC A23L 29/10; A23D 7/0053

(57) ABSTRACT

The present invention relates to a process for producing a preparation comprising or consisting of a protein-carbohydrate conjugate, a preparation comprising or consisting of a protein-carbohydrate conjugate, a process for producing a product for nourishment or pleasure using said preparation, the use of the preparation as an emulsifying agent, and a product for nourishment or pleasure comprising the preparation.

The present invention relates to a process for producing a preparation comprising or consisting of a protein-carbohydrate conjugate, a preparation comprising or consisting of a protein-carbohydrate conjugate, a process for producing a product for nourishment or pleasure using said preparation, the use of the preparation as an emulsifying agent, and a product for nourishment or pleasure comprising the preparation.

Further aspects of the present invention or in connection therewith as well as preferred embodiments appear below as well as in the attached claims.

The “clean label” trend is being steadily driven forward as consumers become increasingly interested in the production methods and ingredients of the products they consume. The food industry is thus striving to make products more attractive to consumers by using natural and easily declarable raw materials. Food additives marked with E-numbers, e.g. emulsifiers, contrast with this trend. These substances are used for the production and stabilisation of emulsion and foam-based foods, such as non-alcoholic fruit drinks and ice cream. To replace these structure-giving substances, proteins of animal or plant origin have gained interest as natural alternatives.

It is known that complexes of proteins and polysaccharides are characterised by emulsifying and foaming capabilities. During adsorption of a protein-polysaccharide complex to an oil/water (O/W) interface, the stabilization of the interface is balanced by aligning hydrophilic building blocks to the aqueous phase and is additionally increased by an increased viscosity of the continuous phase.

The formation of protein-polysaccharide complexes (better known as conjugates) can be induced by covalent bonding between a free amino group of a protein and a reducing carbonyl group of a polysaccharide upon cleavage of water. The conjugation is based on steps of a so-called Amadori rearrangement during the initial phase of the well-known Maillard reaction. The Maillard reaction, also known as non-enzymatic browning reaction, proceeds in several steps. In the initial phase, a glycosylamine is formed, which is converted to stable compounds by the Amadori or Heyns rearrangement. Reddish-brown pigments, the melanoidins, are formed in the last phase of the reaction after a number of intermediate steps and affect their use in a range of food applications.

The known production method of conjugates via Maillard reaction starts from a solution in order to be able to adjust the desired pH value and finally obtain a homogeneous blend of reactants on a molecular level. It proceeds via incubation of a freeze-dried protein carbohydrate dispersion over several days at defined temperature and humidity conditions (approx. 50-70° C., 65-80% humidity). However, due to a high energy consumption during freeze-drying and a long production process with incubation times of up to several days, this conjugation method is prohibitively expensive. Batch processing and several production steps until the conjugates can be further processed are further issues from an economic point of view.

To overcome these problems, initial approaches have been undertaken to develop more cost-effective production methods. Still, many questions remain unanswered and it is questionable whether these approaches can lead to an economically acceptable manufacturing process.

Therefore, a high need exists for improved production methods for protein-carbohydrate conjugates.

It was thus a problem to be solved by the present invention to provide a process for the production of protein-carbohydrate conjugates that at least partly overcomes the disadvantages from which known production methods suffer. In particular, it was an aim to provide a cost-effective that can be implemented on an industrial scale, which process is faster and/or includes fewer steps and which is less energy-demanding as the known processes.

The problem is solved by a process for producing a preparation comprising or consisting of a protein-carbohydrate conjugate as defined by appended claim 1.

The process comprises the steps:
a) providing an aqueous dispersion of a protein and a carbohydrate with adjusted pH;
b) drying the aqueous dispersion at a temperature above its freezing point and a pressure below normal pressure; and
c) forming a glycosylamine by covalently bonding a free amino group of the protein with a carbonyl group of the carbohydrate of the aqueous dispersion.

The present invention resides on the inventors' recognition that protein-carbohydrate conjugates are formed during the drying of an aqueous dispersion of a protein and a carbohydrate (herein also referred to in short as a protein-carbohydrate dispersion) above its freezing point and below normal pressure. In particular, by lowering the pressure below normal pressure, the evaporation temperature of water contained in the protein-carbohydrate dispersion can be reduced resulting in gentle conditions. The conjugation can take place during drying at gentle temperatures and, further advantageously, for a comparatively short time. Thus, in accordance with the process of the present invention, moisture removal from the medium and conjugation may take place simultaneously. In other terms, steps b) and c) may occur simultaneously and/or steps b) and c) may involve the same temperature or temperature profile, and/or steps b) and c) may involve the same pressure or pressure profile. The term “simultaneously” as used herein means that dehumidification and glycosylamine formation occur at least partly concurrently.

By omitting a freeze-drying step, the process of the invention is less costly and energy intensive than known methods. In addition, the dehumidification and glycosylamine formation proceeds quickly so that the overall process time is much shorter than that of known methods. Moreover, it has been found that the exact process parameters, such as the exact temperature, pressure and processing time govern functional properties (emulsifying properties) of the final product. Thereby it is possible to provide products with individual properties by tuning the process parameters using an otherwise identical process.

The expression “normal pressure” as used herein denotes a standard pressure of 1 bar (100 kPa), as defined by the IUPAC. The phrase “below normal pressure” thus means below, i.e. excluding, 1000 mbar, such as 900 mbar or less, 800 mbar or less, 700 mbar or less, 600 mbar or less, 500 mbar or less, 400 mbar or less, 300 mbar or less, 200 mbar or less, 100 mbar or less, etc.

Preferably, the protein-carbohydrate dispersion is present as a continuous phase during step b) and/or step c). It is assumed that the process can then be better controlled and that thereby the desired end product qualities can be more consistently obtained, when the protein-carbohydrate dispersion forms a continuous phase (as compared to a discontinuous phase).

Steps b) and c) may be carried out by vacuum drying in batch mode, for instance in a vacuum drying oven, or continuously, for instance using vacuum belt drying. In a preferred embodiment, steps b) and c) are performed continuously by means off vacuum belt drying, preferably using a vacuum belt dryer with integrated infrared radiation means. Vacuum belt drying enables gentle moisture removal. Moreover, it is suitable for the treatment of highly viscous media, which is a major advantage over other techniques such as spray drying.

Vacuum belt drying involves application of the protein carbohydrate dispersion to one or more belts and drying at low pressure. By reducing the pressure, the evaporation temperature can be reduced, thus drying takes place at lower temperatures (as already mentioned above). The dispersion may for example pass through one or more, e.g. two, three or four, drying zones, in each of which the temperature can be set as desired. The existence of more than one drying zone provides another opportunity to modulate the end product properties.

In an exemplary vacuum belt drying step, capillary water moves towards the surface in the first drying phase. In the second phase, drying takes place mainly on the surface by vapor diffusion. In the third phase, the moist vapor escapes via molecular diffusion. The fourth zone is a cooling zone. The residence time of the suspension in the dryer may be 4 h at maximum. An integrated infrared radiation means increases the energy input into the suspension and thus enables the residence time to be reduced, thus ensuring faster drying.

As mentioned above, the present invention resides on the recognition that protein-carbohydrate conjugates are formed during the drying of a protein-carbohydrate dispersion. This recognition enables to combine steps b) and c) in a single step, wherein dehumidification and glycosylamine formation may take place simultaneously. The term “single step” as used herein is preferably characterized by conditions that do not substantially change within the step. For instance, a temperature difference is less than 100° C., preferably less than 80° C., more preferably less than 60° C., more preferably less than 50° C., yet more preferably less than 40° C. Alternatively or additionally, a pressure difference is less than 300 mbar, preferably less than 200 mbar, more preferably less than 100 mbar, more preferably less than 50 mbar.

According to a further embodiment of the present invention, steps b) and c) involve a temperature of at least 70° C., preferably at least 80° C., more preferably at least 90° C., most preferably at least 95° C. and/or the temperature in steps b) and c) does not exceed 150° C., preferably 140° C., more preferably 130° C., most preferably 120° C. Moreover, steps b) and c) preferably involve a pressure of 500 mbar or less, preferably 300 mbar or less, more preferably 200 mbar or less, more preferably 150 mbar or less, yet more preferably 100 mbar or less, most preferably 50 mbar or less. These temperature and/or pressure conditions can be easily realized, and allow the glycosylamine formation to proceed quickly, yet in a gentle manner so that undesired browning can be prevented.

It is further preferred that steps b) and/or c) are carried out at a pH value of 5.5 to 8.5, preferably 6.0 tom 8.0, more preferably 6.5 to 7.5 and most preferably 6.7 to 7.3.

Moreover, process efficiency can be increased and browning reduced by limiting the duration of the exposure to increased temperatures. It is thus further preferred that steps b) and c) do not exceed a total duration of 16 h, preferably 12 h, more preferably 8 h, more preferably 6 h, yet more preferably 5 h, most preferably 4 h. In some embodiments, steps b) and c) last for 3 h or less, or about 2 h. Moreover, it is preferred that the total duration is at least 2 hours. Most preferably, steps b) and c) lasts for about 2 h to about 4 h.

According to a further embodiment of the present invention, before step b) the dry weight of protein and carbohydrate is 40% or less, preferably 30% or less, more preferably 20% or less, most preferably 15% or less, relative to the total weight of the aqueous dispersion, and/or before step b) the dry weight of protein and carbohydrate is at least 1%, preferably at least 2%, more preferably at least 3%, at least 4%, at least 5%, most preferably at least 6% or at least 7%, relative to the total weight of the aqueous dispersion. In other words, the above values define preferred dry matter contents of the aqueous dispersion immediately before it underwents drying step b). Further, after step b) and/or after step c) the dry weight of protein and carbohydrate is preferably at least 60%, preferably at least 70%, more preferably at least 75%, most preferably at least 80%, relative to the total weight of the dried aqueous dispersion.

A weight ratio of the protein to the carbohydrate represents another opportunity for variation. In this regard, it is preferred that the weight ratio of the protein to the carbohydrate ranges from 1:5 to 5:1, preferably 1:4 to 4:1, more preferably 1:3 to 3:1, more preferably 1:2 to 2:1, most preferably 1:1 to 2:1.

In a further embodiment of the present invention, the protein is nature-derived protein. A nature-derived protein as understood herein can be a naturally occurring protein or a protein functionally identical and structurally similar to a naturally occurring protein. Structurally similar as defined herein denotes an amino acid sequence that is at least 90%, preferably at least 95%, more preferably at least 96%, more preferably at least 97%, most preferably at least 98%, identical to a query sequence. Preferably, the protein is a vegetable or animal protein, more preferably a vegetable protein or a whey protein isolate.

For instance, the protein may be selected from the group consisting of potato, rape, pea, soya and whey protein isolates.

In a further embodiment of the present invention, the carbohydrate is selected from the group consisting of monosaccharides, disaccharides and polysaccharides, preferably pectins and dextrans, in particular pectins. In addition to unmodified pectins, pectins also include modified variants thereof. Pectins belong to the group of polyuronides, polysaccharides which contain uronic acid (e.g. galacturonic acid) in their chemical composition.

In a further embodiment of the present invention, the dispersion comprises a fruit extract. In other terms, a fruit extract has been used as a source for the carbohydrate. This embodiment addresses the consumers' demand for products that are as natural as possible.

Another aspect of the present invention is a preparation containing or consisting of a protein-carbohydrate conjugate, preferably prepared by a process as disclosed herein, wherein:
the protein is a vegetable protein (preferably selected from the group consisting of potato, rape, pea and soya isolates), or a whey protein isolate; and
the carbohydrate is selected from the group consisting of dextrans and pectins.

Preferably one or more of the following additionally applies:
(i) the preparation is characterized by a browning index (BI) of 50 or less, preferably 40 or less, more preferably 30 or less, more preferably 25 or less, yet more preferably 20 or less, most preferably 15 or less;
(ii) the carbohydrate has a molecular weight of at least 1 kDa, preferably at least 2 kDa, more preferably at least 3 kDa, yet more preferably at least 4 kDa, most preferably at least 5 kDa;
(iii) the carbohydrate is pectin, preferably an amidated pectin;
(iv) the preparation has a pH value of 5.5 to 8.5, preferably 6.0 tom 8.0, more preferably 6.5 to 7.5 and most preferably 6.7 to 7.3.

The browning index (BI) as understood herein is defined as BI=[100 (x−0.31)]/0.17, where x=(a*+1.750/(5.645L*+a*−0.3012b*). The parameters L*, a*, b* are the corresponding values in the CIELAB colour space. The BI may serve as an indication of the progress of the Maillard reaction and hence for the evaluation of the end product.

It is to be understood that the molecular weight of the protein-carbohydrate conjugate largely depends on the molecular weight of the protein and carbohydrate used.

In some embodiments, the carbohydrate is a pectin having a molecular weight of 100 to 500 kDa, preferably 200 to 400 kDa, more preferably 250 kDa to 350 kDa.

Another aspect of the present invention concerns a process for producing a product for nourishment or pleasure, comprising the steps:
a) carrying out the process for producing a preparation comprising or consisting of a protein-carbohydrate conjugate (as disclosed herein) or providing a preparation comprising or consisting of a protein-carbohydrate conjugate (as disclosed herein);
b) preparing an emulsion using the preparation as an emulsifying agent; and
c) combining the preparation with further components of the product for nourishment or pleasure before and/or after the preparation of the emulsion.

Another aspect of the present invention is the use of a preparation comprising or consisting of a protein-carbohydrate conjugate (as disclosed herein) as an emulsifying agent, preferably in a product for nourishment or pleasure.

A final aspect of the present invention relates to a product for nourishment or pleasure, preferably prepared by a process for producing a product for nourishment or pleasure (as disclosed herein), comprising a preparation comprising or consisting of a protein-carbohydrate conjugate (as disclosed herein).

The present invention, preferred embodiments thereof and several aspects in connection therewith will be described further below in the form of selected examples.

In the drawings:

FIG. 1 shows a vacuum belt dryer as disclosed herein. The reference signs indicate: 1: Sample inlet valve. 2: Swivel mechanism. 3: IR heating means. 4: Conveyer belt with contact heating means. 5: Dropout. 6: Collecting device. I-IV: Heating/temperature zones.

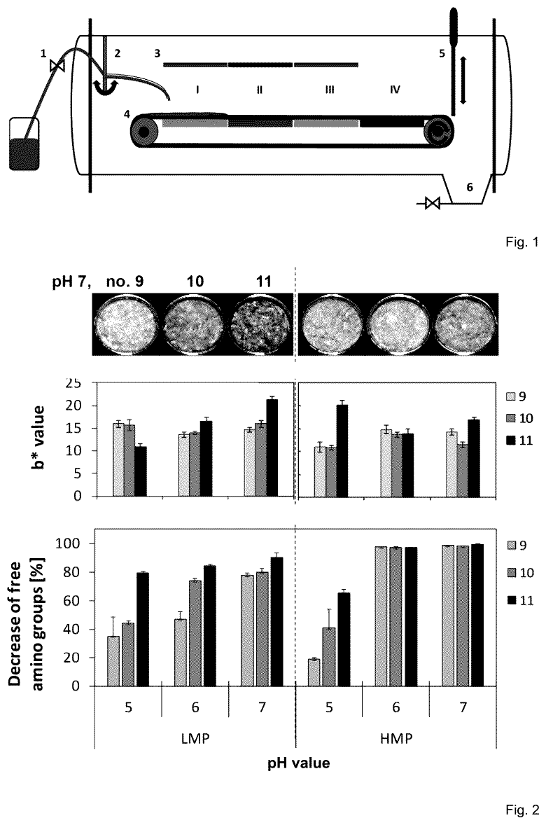

FIG. 2 shows the results for example 1. Conjugates were produces using different heating profiles resulting in samples nos. 9, 10 and 11. High-methoxylated pectin (HMP) and low-methoxylated pectin (LMP) served as carbohydrate component. Three different pH values (5-7) have been tested.

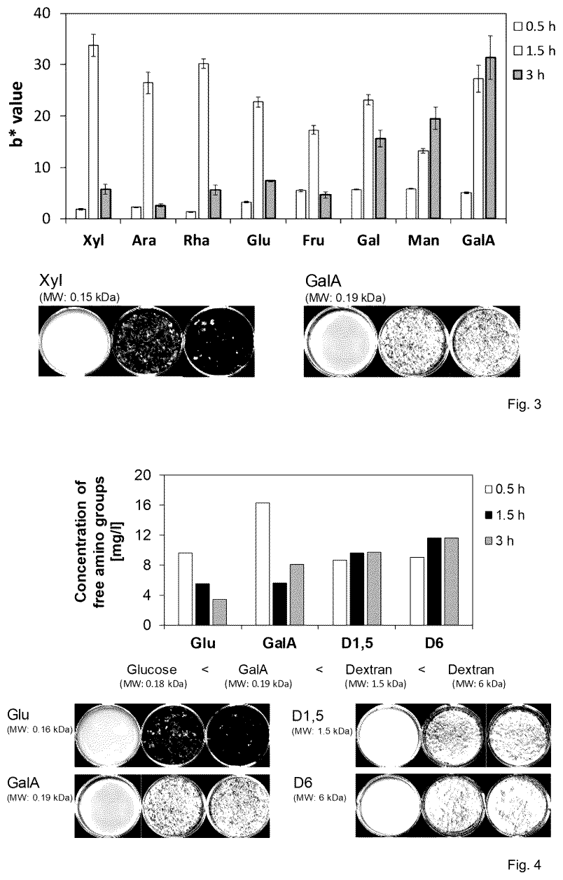

FIG. 3 shows the results of example 2, where different sugars, which can be contained in the neutral sugar chains of pectin, have been tested: Xylose (Xyl), arabinose (Ara), rhamnose (Rha), glucose (Glu), fructose (Fru), galactose (Gal), mannose (Man) and galacturonic acid (GalA).

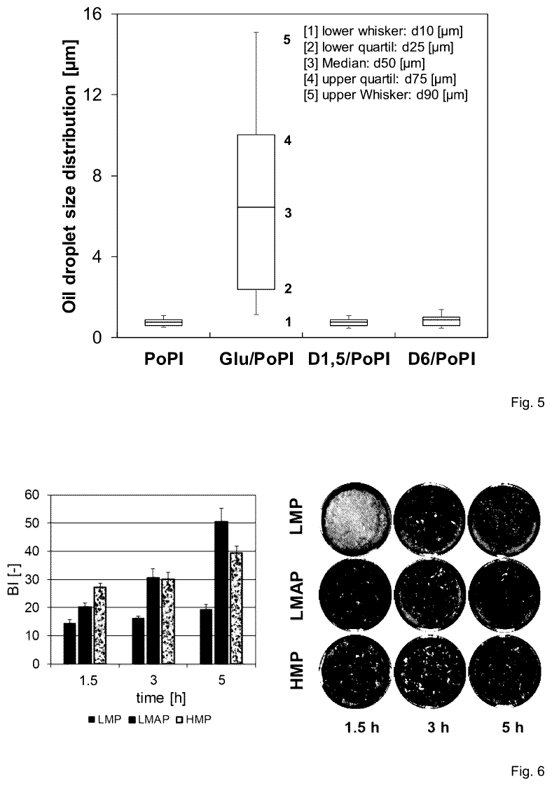

FIGS. 4 and 5 show the results of example 3. The results for two different dextrans, dextran having a molecular weight of 1.5 kDa (D1,5) and dextran having a molecular weight of 6 kDa (D6), as compared to specific conjugate samples from example 2 (Glu, GalA). The dextrans served as a carbohydrate component, whereas potato protein isolate (PoPI) served as protein component. FIG. 5 shows the oil droplet size distribution for an emulsion produced using the conjugates of example 3 as an emulsifier, as compared to an emulsion produced using a conjugate of example 2 as an emulsifier (Glu/PoPI) and an emulsion using potato protein isolate (PoPI) as an emulsifier.

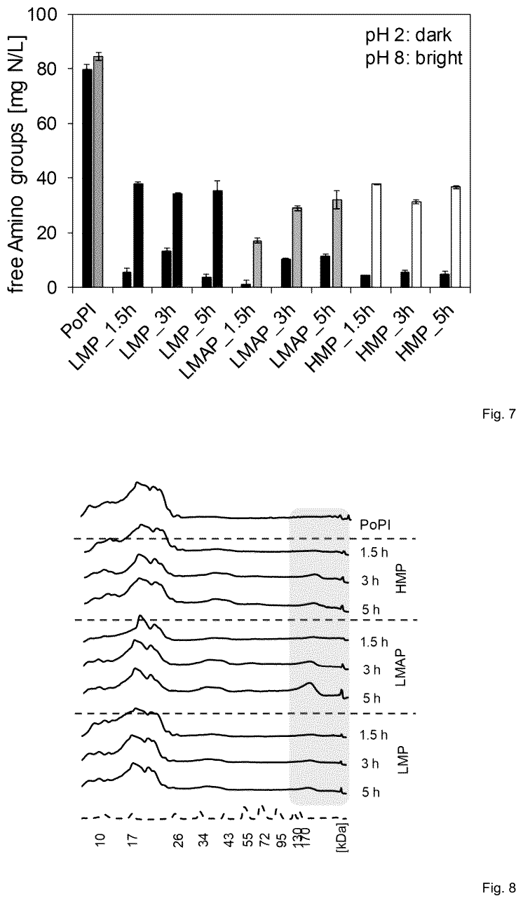

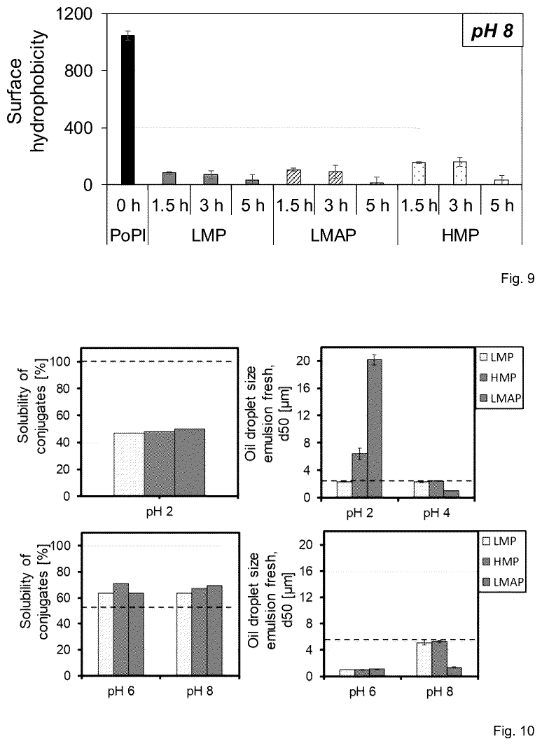

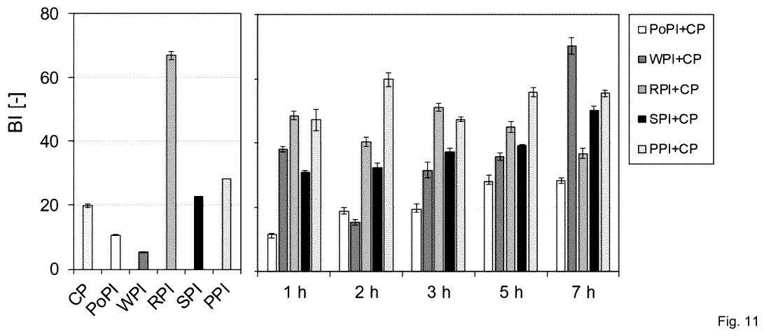

FIGS. 6 to 10 show the results of example 4, in which potato protein isolate (PoPI) served as a protein component and citrus pectins served as a carbohydrate component. The following citrus pectins were used: low-methoxylated DM 33 (LMP), high-methoxylated DM 69 (HMP), and low-methoxylated, amidated DM 32 and DA 19 (LMAP). FIG. 6 shows the degree of browning as a function of the heating time (1.5 h, 3 h, 5 h were tested). FIG. 7 shows the free amino groups as compared to the source protein (PoPI). FIG. 8 shows results on the determination of the molecular weight of the formed conjugates, again in comparison to that of the source protein (PoPI). The surface hydrophobicity determined at pH 8 is shown in FIG. 9. FIG. 10 shows solubility results and results of emulsion experiments.

FIGS. 11 to 15 show the results for example 5. In this example, high-methoxylated DM 70 citrus pectin (HMP) served as a carbohydrate component, whereas different protein isolates were testes as a protein component: Potato protein isolate (PoPI), whey protein isolate (WPI), canola protein isolate (RPI), pea protein isolate (PPI) and soy protein isolate (SPI).

### EXAMPLES

1 Material and Methods

With respect to example 1 (FIGS. 1 and 2), Protein-uronide conjugates were produced as exemplary protein-carbohydrate conjugates. A potato protein isolate (PoPI, 93.2% protein w/w) was used as the protein component. Commercial citrus pectins, among them the high-methoxylated (DM 68-76%, HMP) and low-methoxylated pectin (DM 32-42%, LMP), were used as uronide component.

With respect to examples 2 and 3 (FIGS. 3, 4 and 5), potato protein isolate (PoPI, 93.2% protein w/w) was conjugated with the following carbohydrates:

| Material | Description | Comments |
|---|---|---|
| Arabinose | L(+)-Arabinose | 0.15 kDa |
| Dextran | Dextran from Leuconostoc ssp. | 1.5 kDa |
| Dextran | Dextran from Leuconostoc | 6 kD |
| | mesenteroides | |
| Fructose | D-Fructose | 0.18 kDa |
| Galactose | D(+)-Galactose | 0.18 kDa |
| Galacturonic acid | D(+)-Galacturonic acid | 0.19 kDa |
| Glucose | D(+)-Glucose | 0.18 kDa |
| Mannose | D(+)-Mannose | 0.18 kDa |
| Rhamnose | L(+)-Rhamnose monohydrate | 0.16 kDa |
| Sucrose | D(+)-Sucrose | 0.34 kDa |
| Xylose | D-Xylose from maize | 0.15 kDa |

With respect to example 4 (FIGS. 6 to 10), Commercial citrus pectins, high-methoxylated (DM 69%, HMP), low-methoxylated (DM 33%, LMP) and low-methoxylated, amidated pectin (DM 32%, DA 19%, LMAP) was further used for conjugation with potato protein isolate (PoPI, 93.2% protein w/w).

With respect to example 5 (FIGS. 11 to 15), Five protein isolates were obtained by different companies, whey protein (WPI, 98.7% protein w/w), potato protein (PoPI, 93.2% protein w/w), canola protein (RPI, 90% protein w/w), soy protein (SPI, 92.2% protein w/w) and pea protein (PPI, 88.7% protein w/w). The high-methoxylated commercial citrus pectin (CP, DM 70%) was used as uronide component.

Further referring to example 1, to produce the conjugates, protein-pectin dispersions were produced with a final dry matter content of 10% at two different ratios of the two components (2:3 and 1:1, protein:pectin). The type of pectin (HMP or LMP) and the pH value were varied. The individual components were dissolved separately in water under continuous stirring with a magnetic stirrer (MP Hei-Standard, Heidolph Instrument GmbH & Co, Schwabach, Germany). The pectin dispersion was additionally tempered to approx. 50° C. Afterwards the separate dispersions were adjusted to the desired pH value (pH 5, 6, 7) using acetic acid (0.5 mol) and/or caustic soda (NaOH, 0.5 mol) and a pH meter (Portames 911 pH, Knick Elektronische Messgerate GmbH & Co. KG, Berlin, Germany) and then merged. The finished dispersion was stirred with an agitator from IKA®-Werke GmbH & Co. KG (Staufen, Germany) and the pH value was controlled and adjusted if necessary.

The dispersions were dried by means of a vacuum belt dryer with integrated infrared (IR) heating (Baby-VBD, Merk Process, Laufenburg, Germany). In preliminary tests, suitable process conditions were optimized for the preparation of conjugates with a final dry substance over 70% and characteristic Maillard staining. Temperature, vacuum pressure and residence time can be varied. The temperature of the contact heating means (CT) was set 20° C. lower according to the manufacturers specifications. The vacuum pressure was 10 mbar and kept constant over the specified residence time of 90 min. The swivel mechanism by which the sample was applied to the conveyor belt had a speed of 5% and a swivel width of 150 mm, so that the sample was evenly distributed on the belt and could not run down the sides. The speed of the belt was controlled by the residence time and was 90 min as above. The dried sample was separated at the end of the belt in 10 s cycles. The dispersions were fed into the interior of the vacuum belt dryer by the vacuum present in the vacuum belt dryer when the sample inlet valve was opened. The vacuum belt dryer had four sections in which individual temperature zones were set. The vacuum belt dryer used in example 1 is schematically shown in FIG. 1.

In example 1, the following temperature zones were used:

| Sample | Temperature [° C.] | | | |
|---|---|---|---|---|
| no. | Zone 1 | Zone 2 | Zone 3 | Zone 4 |
| 9 | 60/80 | 80/100 | 80/100 | 15/— |
| 10 | 60/80 | 100/120 | 80/100 | 15/— |
| 11 | 60/80 | 120/140 | 80/100 | 15/— |

Examples 2 to 5 were performed using a vacuum drying oven at 50 mbar and 100° C. The heating time was between 1.5 and 7 h.

Characterization of Protein-Uronide Conjugates

Dry Substance

The dry matter of the samples was analyzed with a moisture analyzer (Moisture Analyzer HG53, Mettler-Toledo GmbH, Greifensee, Switzerland). Approximately 1 g of sample was dried at 140° C. with halogen lamps until the mass was constant.

Reduction of Free Amino Groups

To determine the concentration of free amino groups in the protein as well as in the conjugate samples, an assay kit (Primary Amino Nitrogen Assay Kit (PANOPA) from Megazyme u.c., (Wicklow, Ireland)) was used. The method is based on photometric determination of the amount of isoindole derivatives formed in this reaction, which stoichiometrically correspond to the amount of free amino groups. The reaction proceeds in two steps. In the first step, the sample, distilled water as blank or isoleucine standard solution for the calibration line is mixed with NAC/buffer and after 2 min absorption is measured at 340 nm using a UV/Visible spectrophotometer (Ultrospec 1100 pro, Biochrom Ltd, Cambridge, England) in disposable cuvettes (PMMA, BRAND GmbH+Co KG, Wertheim, Germany). The reaction is initiated by adding OPA reagent to the measured solution. After 15 min, at the end of the reaction, the absorbance is measured again. The nitrogen from the amino groups of the free amino acids in the sample reacts with N-acetylene L-cysteine and o-phthaldialdehyde to form isoindole derivatives. The concentration of free amino groups is calculated by means of the straight line equation of the calibration line, which is created before each measurement with iso-leucine standard solution. The analysis was performed strictly according to the manufacturers specifications. The samples were prepared for this purpose in double determination in protein concentration of 0.1%, stirred overnight and measured in triplicates.

Color

The determination of the characteristic brown coloration resulting from the Maillard reaction was performed with a spectrophotometer (CM-5, Konica Minolta, Marunouchi, Japan) via CIELAB system. The L* value is the luminance value (0=black, 100=white) and indicates the brightness of the sample. The a* value indicates the intensity of the red (positive values) and green color (negative values) and the b* value describes the range of yellow (positive values) and blue (negative values). Each sample was measured six times, and the b*-value directly (FIGS. 2, 3) or the determined Browning Index (BI) was used for evaluation. BI=[100(x−0.31)]/0.17, where x=(a*+1.750/(5.645L*+a*−0.3012b*) (FIGS. 6, 11).

Molecular Weight

The determination of the molecular weight distribution of the conjugates and the corresponding protein was performed using SDS-Page with 12% Criterion™ TGX™ Gel with 26 wells (BioRad Laboratories GmbH, Munchen, Germany). The gel was loaded with 5 μL of molecular weight marker (PageRuler™ Prestained Protein Ladder, Cat #26616, ThermoScientific) and 10 μL of samples (0.15% protein in Biorad 2×Laemmli sample buffer (Cat #161-0737). The separation of the proteins into molecular weights was performed at 200 V (const.), 0.14 A and 300 W for a minimum of 37 min up to a maximum of 50 min in a running chamber (Criterion™ Cell) filled with running buffer Biorad 10×Tris/Glycine/SDS (Cat #161-0732) by means of a running chamber electrical device (PowerPAC™ HC). The gels were photographed and evaluated with the software ImageJ 1.52d (Schneider, Rasband, & Eliceiri, 2012) by transforming the bands into peaks.

Determination of Hydrophobicity

The hydrophobicity of the samples was measured using a fluorescence spectrophotometer (Cary Eclipse Fluorescence Spectrophotometer, Agilent Technologies, Victoria, Australia) via fluorescent labeling using 8-anilinonaphthalene-1-sulfonic acid (ANS, >97%, Sigma Aldrich, St. Louis, USA). Five dilutions of each conjugate or protein sample (0.001%, 0.002%, 0.003%, 0.004% and 0.005% w/w protein content prepared from stock solution) were analyzed in triplicates without and with the addition of 20 μL ANS solution (8 mmol), at pH 2 and pH 8. The adsorption measurements were performed in a quartz cuvette at an absorbance of 380 nm and an emission of 470 nm with a split of 5 nm. The calculated emisson values were plotted against the concentration of the solutions and the slope of the resulting straight line represented the hydrophobicity of the sample.

Characterization of the Functionality of the Conjugates

Solubility Determination According to DUMAS

The solubility of the protein and conjugate samples was determined according to Dumas using Dumatherm (Gerhardt GmbH&Co. KG, Königswinter, Germany). By determining the quantitative nitrogen content of the sample, the percentage protein content is calculated taking into account the protein factor. The protein content can then be used to calculate the solubility of the sample. 1% sample solutions with pH 2, 4, 6 and 8 were analyzed. The samples were measured directly and the supernatant of the samples was measured after centrifugation at 10,000 g for 20 min using a benchtop centrifuge (Centrifuge MiniSpin, Eppendorf AG, Hamburg, Germany). The solubility is calculated by dividing the protein content of the total sample and of the dissolved fraction:

$$: S = \frac{{c}_{soluble content}}{{c}_{total content}} \cdot 100 \% S$$

Production of Emulsions

To produce emulsions, a pre-emulsion was produced by means of a high-performance dispersing device (ULTRA-TURRAX® T 25 basic, IKA®-Werke GmbH & Co KG, Staufen, Germany) at 13,500 min⁻¹ for 60 s. The aqueous phase—suspended protein (0.2% w/w) or conjugate sample (0.2% w/w protein content) in phosphate citrate buffer (0.01 M) at pH 2, 3, 4, 6, 8, were emulsified with 5% rapeseed oil (purity of 92% from local supermarket). The oil was dyed with a red-dying, hydrophobic azo dye (Oil Red 0, 0.017%) to differentiate the phases in case of possible destabilization. The subsequent fine dispersion was carried out using a high-pressure homogenizer (Panda 2K, GEA Niro Soavi Deutschland, Lubeck, Germany) at 300 bar in 2 passes.

Oil Droplet Size

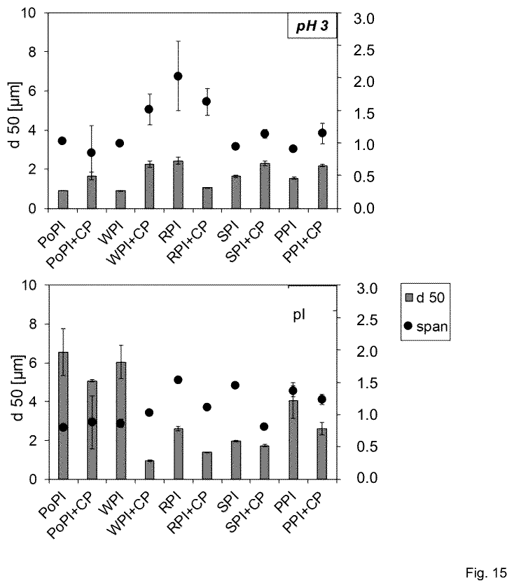

The size distribution of oil droplets is determined by means of static laser light scattering (Horiba LA-950, Retsch Technology GmbH, Haan, Germany). For all measurements a refractive index of 1.47 was chosen as well as a circulation velocity of 8 and a stirring velocity of 3. The output oil droplet size distribution is displayed as a box plot with 5 points (d₁₀, d₂₅, d₅₀, d₇₅ and d₉₀) (FIG. 5) or the median of the distribution (d₅₀) is directly considered (FIGS. 10, 15).

Further details in regard of the proteins and carbohydrates used as well in regard of production conditions applied can be found in the following table:

| | | | Weight ratio | Dry matter | | |
|---|---|---|---|---|---|---|
| | Protein component | | protein to | content¹ | pH | |
| Ex. | (protein isolates) | Carbohydrate component | carbohydrate | [%] | value | Processing device |
| 1 | Potato (protease inhibitors, | commercial pectins: | 2:3 | 10 | 5, 6, 7 | Vacuum belt dryer |
| | IEP 5-9) (PoPI) | high-methoxylated pectin (DM 68-76%, HMP), low- | | | | |
| | | methoxylated pectin (DM 32-42%, LMP) | | | | |
| 2 | | Xyl, Ara, Rha, Man, Glu, Gal, Fru, GalA (0.15-0.19 | 2:1.5 | 7 | 7 | Vacuum drying oven |
| | | kDa) | | | | (50 mbar, 100° C., 1.5 |
| 3 | | dextrans (1.5 and 6 kDa) | 2:1.5 | 7 | 7 | h) |
| 4 | | Citrus Pectins: | 2:1.5 | 7 | 7 | |
| | | low-methoxylated DM 33 (LMP)high-methoxylated | | | | |
| | | DM 69 (HMP) | | | | |
| | | low-methoxylated, amidated DM 32 and DA 19 | | | | |
| | | (LMAP) | | | | |
| 5 | Potato, 93.2%, IEP 5-9 (PoPI) | Citrus pectin: | 2:1.5 | 7 | 7 | Vacuum drying oven |
| | Whey, 98.7%, IEP 5 (WPI) | high-methoxylated VG 70 (HMP) | | | | (50 mbar, 100° C., 1, |
| | Canola, 90%, IEP 7-11 (RPI) | | | | | 2, 3, 5, 7 h) |
| | Pea, 88.7%, IEP 5 (PPI) | | | | | |
| | Soy, 92.2%, IEP 4-8 (SPI) | | | | | |

¹Dry weight of protein component to carbohydrate component relative to the total weight of the dispersion

2. Results

### a) Example 1

The results of example 1 are shown in FIG. 2.

As can be seen in FIG. 2, at pH 7 browning was strongest, which pH value is thus assumed to be the optimum for the Maillard reaction. A higher decrease of free amino groups with lower colour formation at pH 7 was observed with high-methoxylated pectin (HMP) as compared to low-methoxylated pectin (LMP). This means that the Maillard reaction is in the desired “early” stage and it can be assumed that more functional conjugates and less degradation products are present in the sample. However, it was concluded that vacuum belt drying serves as a continuous alternative for the conjugation between protein and polysaccharide such as pectin. It could be shown that during the drying process the Maillard reaction took place simultaneously, led to the formation of a glycosylamine by covalently bonding a free amino group of the protein with a carbonyl group of the polysaccharide.

### b) Example 2

The results of example 2 are shown in FIG. 3.

Looking at the individual sugars contained in the neutral sugar chains of pectin, can be seen in FIG. 3, Xylose (Xyl) is the most reactive sugar. Further, the chemical structure of sugars determines their reactivity as follows: ketose>aldose, pentoses>hexoses.

It can be concluded that these model experiments confirm the Maillard reaction and the resulting formation of covalent bonds between protein and sugar. On the other hand, it can be postulated that the pectins containing xylose as reducing sugar in the neutral sugar chain have an increased reactivity.

### c) Example 3

The results of example 3 are shown in FIG. 4.

As can be seen in FIG. 4, with increasing chain length of the sugars the reactivity of the sugars decreased. As a result, the Maillard reaction slowly progressed resulting in limited browning, though functional conjugates were successfully formed.

Furthermore, FIG. 5 shows the results obtained for an emulsion produced using the conjugates of example 3 as an emulsifier. The emulsion was prepared using 0,2% (w/w protein content) conjugates as an emulsifier, 5% rape seed oil and a buffer pH 3.4 following the protocol described in the method section (pre-emulsion: 1.5 min at 13500 1/min (Ultra-Turrax), emulsion: 300 bar, number of passes 2 (high pressure homogenizer)).

Creaming of the emulsion produced with monosaccharide-protein conjugates was rapidly seen, however, a stabilization of the emulsion failed. In comparison, it was showed that an improved stability of emulsions will be achieved by conjugates with higher molecular weight polysaccharides it was found that an improved stability of emulsions is achieved by conjugates with polysaccharides of higher molecular weight. At pH 3 no clear difference to the emulsion stabilised by protein could be detected due to the high functionality of the protein at this pH value.

### d) Example 4

The results of example 4 are shown in FIGS. 6 to 10.

As can be seen in FIG. 6, with increasing heating time, the Maillard reaction strongly progressed, with LMAP conjugates showing the strongest progression.

The conjugation rate was over 50%. The free amino groups decreased with heating time. At pH 2, significantly fewer free amino groups were detected as compared to pH 8. No significant differences were observed between the individual pectin conjugates (cf. FIG. 7).

The molecular weight increased above 170 kDa with heating time (cf. FIG. 8), which is particularly significant in samples with LMAP.

A strong decrease of the surface hydrophobicity of the protein by conjugation with pectins was further observed. This was associated with an improvement of the emulsifying properties, especially by conjugation with amidated pectin (LMAP) (cf. FIG. 9).

Referring to FIG. 10, at the IEP, the functional properties of the potato protein isolate could be improved by conjugation with pectins. The solubility and emulsion stability were thereby increased.

It was concluded that vacuum drying leads to formation of conjugates within a few hours, associated with an increase of the molecular weight, a decrease of free amino groups and an improvement of emulsifying properties as compared to the neat protein. At the target pH value (pH 3) for beverage emulsions, conjugation of the potato protein does not lead to an improvement of functional properties in the acidic environment. This is because PoPI has already excellent functional properties in the acidic environment. At pl (pH 5-9) of potato protein, the functional properties could be improved by conjugation with pectins. Solubility and emulsion stability were increased.

### e) Example 5

The results of example 5 are shown in FIGS. 11 to 15.

FIG. 11 shows that with increasing heating time, the Browning Index increased for all conjugates except the canola protein (RPI) samples. It is noted in this regard that due to the intrinsic coloration of the canola protein, the colour of the canola protein conjugates is not exclusively due to the conjugation.

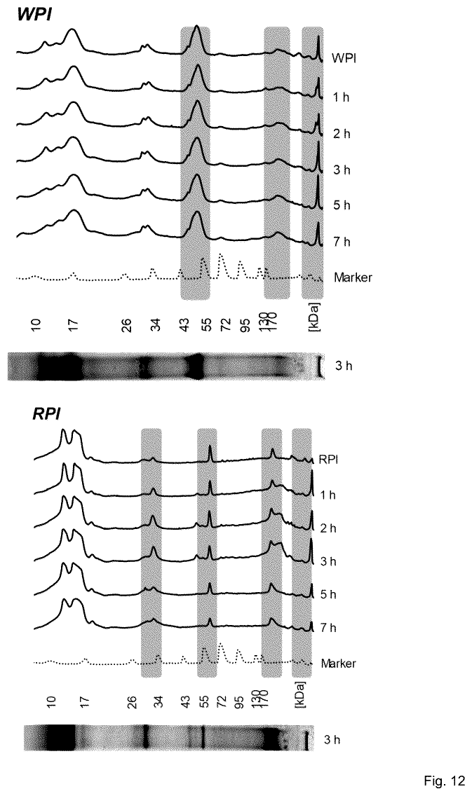

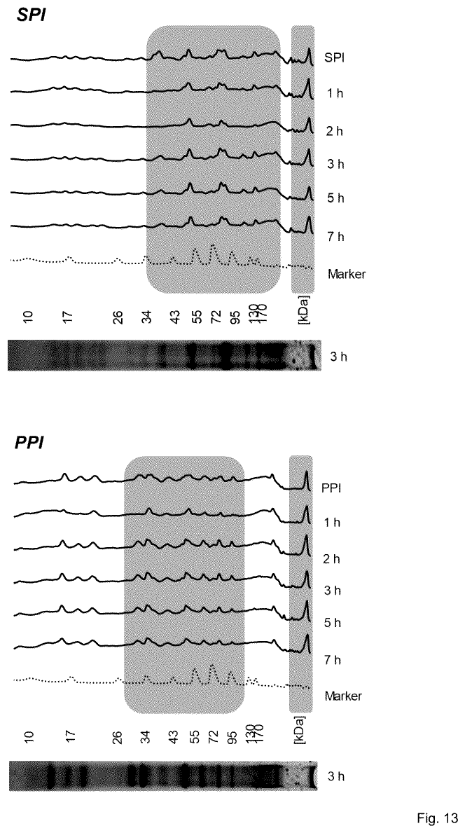

Generally, an increase in molecular weight over the heating time was observed. From 5 h conjugation time on, degradation of the high molecular weight complexes occurred. The molecular weight was above 170 kDa. (cf. FIG. 12). Due to high molecular weight fractions in the source protein, no clear increase in molecular weight is detectable in the soy (SPI) and pea protein (PPI) samples (cf. FIG. 13). The molecular weight variations were in the range 34 to 170 kDa for the soy protein isolate and 34 to 130 kDa for the pea protein isolate.

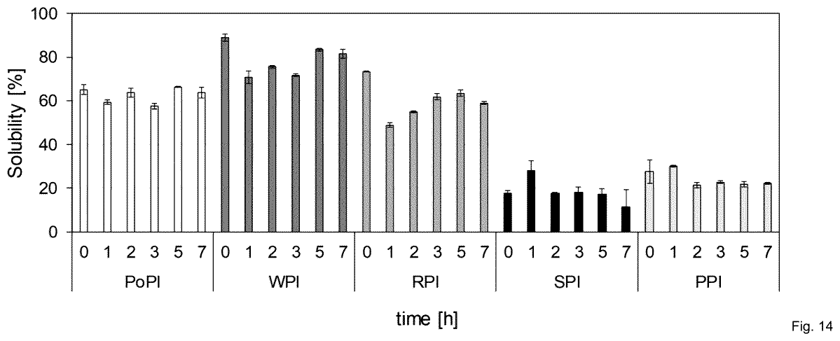

As seen in FIG. 14, the conjugates have a similar or worse solubility compared to the respective neat starting protein. Independent of the starting proteins, the solubility increases with conjugation time for whey protein (WPI) and canola protein (RPI) conjugates.

Referring to FIG. 15, it can be seen that at the target pH value (pH 3) all emulsions showed a cream phase despite small oil droplet sizes. The functional properties of the proteins were improved at the respective pl.

It was concluded that vacuum drying leads to the formation of conjugates with a high molecular weight (MG>170 kDa) and improved emulsifying properties at the respective pl. At the target pH value (pH 3) for beverage emulsions, conjugation of proteins of different origin with high methylester pectin does not lead to a clear improvement of the functional properties. This of course depends on the respective fraction and isoelectric point of the used protein.

1-15. (canceled)

16. A process for producing a preparation comprising a protein-carbohydrate conjugate, the process comprising:
(a) providing an aqueous dispersion of a protein and a carbohydrate;
(b) drying the aqueous dispersion at a temperature above its freezing point and a pressure below 1000 mbar; and
(c) forming a glycosylamine by covalently bonding a free amino group of the protein with a carbonyl group of the carbohydrate.

17. The process of claim 16, wherein (b) and (c) occur simultaneously, and/or involve the same temperature or temperature profile, and/or involve the same pressure or pressure profile.

18. The process of claim 16, wherein (b) and (c) are performed continuously.

19. The process of claim 16, wherein (b) and (c) are carried out a temperature of at least 70° C.

20. A process of claim 16, wherein (b) and (c) are carried out at a pressure of 500 mbar or less.

21. A process of claim 16, wherein (b) and (c) do not exceed a total duration of 16 hours.

22. A process of claim 16, wherein before (b) the protein and carbohydrate are in a dry weight of 40% or less.

23. A process of claim 16, wherein a weight ratio of the protein to the carbohydrate is 1:5 to 5:1.

24. A process of claim 16, wherein the protein is a nature-derived protein.

25. A process of claim 16, wherein the carbohydrate is selected from monosaccharides, disaccharides, and polysaccharides.

26. A process of claim 16, wherein the dispersion comprises a fruit extract.

27. A preparation comprising a protein-carbohydrate conjugate prepared by the process of claim 16, wherein the protein is a whey protein isolate or a vegetable protein; and the carbohydrate is selected from dextrans and pectins.

28. A process for producing a product for nourishment or pleasure, the process comprising:
(a) obtaining the preparation of claim 27;
(b) preparing an emulsion using the preparation as an emulsifying agent; and
(c) combining the preparation with further components of the product for nourishment or pleasure before and/or after preparation of the emulsion.

29. A method for emulsifying a composition comprising adding the preparation of claim 27 to a composition and emulsifying the composition.

30. A product for nourishment or pleasure prepared by the process of claim 28.

31. The process of claim 18, wherein (b) and (c) are performed continuously using a vacuum belt drying.

32. The process of claim 31, wherein (b) and (c) are performed continuously using a vacuum belt dryer with an infrared radiation means for heating.

33. The preparation of claim 27, wherein the preparation comprises a browning index (BI) of 50 or less.

34. The preparation of claim 27, wherein the carbohydrate has a molecular weight of at least 1 kDa.

35. The preparation of claim 27, wherein the carbohydrate is an amidated pectin.
